(19) United States
(12) Patent Application Publication
(10) Pub. No.: US 2020/0272897 A1
(43) Pub. Date: Aug. 27, 2020

(54) LEARNING DEVICE, LEARNING METHOD, AND RECORDING MEDIUM

(71) Applicant: NEC CORPORATION, Tokyo (JP)

(72) Inventor: Masato ISHII, Tokyo (JP)

(73) Assignee: NEC CORPORATION, Tokyo (JP)

(21) Appl. No.: 16/762,571

(22) PCT Filed: Nov. 19, 2018
(86) PCT No.: PCT/JP2018/042665

§ 371 Date: May 8, 2020

(30) Foreign Application Priority Data
Nov. 22, 2017 (JP) 2017-224833

(51) Int. Cl. G06N 3/08; G06N 3/04; G06N 20/00

(52) U.S. Cl. CPC G06N 3/08; G06N 20/00; G06N 3/0454

(57) ABSTRACT

A learning device according to the present invention includes, in semi-supervised learning using domain information: a memory; and a processor. The processor performs operations. The operations includes: including a first neural network outputting data after predetermined conversion by using first data including the domain information and second data not including the domain information, a second neural network outputting a result of predetermined processing by using data after the conversion, and a third neural network outputting a result of domain discrimination by using data after the conversion; calculating a first loss being a loss of the domain discrimination; calculating a second loss being an unsupervised loss; calculating a third loss in the predetermined processing; and modifying a parameter of each of the first neural network to the third neural network in such a way as to decrease the second loss and the third loss and increase the first loss.

### TECHNICAL FIELD

The present invention relates to machine learning of data, and more specifically relates to semi-supervised learning.

### BACKGROUND ART

A pattern recognition technique is a technique for estimating to what class a pattern input as data belongs. As a specific example of pattern recognition, object recognition for estimating an appearing object by using an image as input, voice recognition for estimating an utterance content by using a voice as input, or the like is cited.

In pattern recognition, statistical machine learning is widely used. Statistical machine learning learns a model indicating a statistical nature between a pattern and a class of the pattern, by using supervised data (hereinafter, referred to as “learning data”) previously collected. Since supervised data are used, such learning is also referred to as “supervised learning”.

In statistical machine learning, a learned model is applied to a pattern to be recognized (hereinafter, referred to as “test data”) and thereby a result of pattern recognition for test data is acquired. Test data are unsupervised data.

In many methods of statistical machine learning, it is assumed that a statistical nature of learning data and a statistical nature of test data are matched with each other. Therefore, when statistical natures are different in learning data and test data, performance of pattern recognition decreases, depending on a degree of a difference between the statistical natures.

A cause in which statistical natures are different between learning data and test data includes, for example, attribute information other than class information being a target of pattern recognition (classification of a pattern). Attribute information in this case is information relating to an attribute other than a class used for classifying a pattern, in learning data and test data.

An example in which attribute information other than a class affects distribution of data is described. For example, detection of a facial image using an image is considered. In this case, class information includes, for example, a “facial” image and a “non-facial” image. However, it is assumed that a position of illumination in capturing a facial image is not fixed with respect to a face. In this case, for example, an image of a scene where strong illumination is received from right with respect to a capturing direction and an image of a scene where strong illumination is received from left are largely different in statistical nature (e.g. appearance). In this manner, statistical natures in data of a facial image and a non-facial image are changed based on an “illumination condition” being attribute information other than class information referred to as a face and a non-face.

As attribute information other than “illumination information”, a “capturing angle” or “characteristics of a camera used for capturing” are assumed. In this manner, there are a large number of pieces of attribute information affecting a statistical nature (e.g. distribution of data) other than class information.

However, it is difficult to match all pieces of attribute information in learning data and test data. As a result, in learning data and test data, statistical natures may be frequently different in at least partial attribute information.

As one example of a technique for correcting a gap of statistical natures between pieces of data as described above, domain adaptation is known (see, for example, NPL 1 and PTL 1). Domain adaptation is a technique for acquiring, in order to find an efficient hypothesis for a new task, knowledge (data) learned by one or more other tasks and adopting the knowledge (data). In other words, domain adaptation is to adapt (or transfer) a domain of knowledge (data) of a certain task to a domain of knowledge of another task. Alternatively, domain adaptation is a technique for converting a plurality of pieces of data in which statistical natures shift from each other in such a way that the statistical natures are sufficiently close to each other. A domain in this case is a region of a statistical nature.

Domain adaptation may be referred to as transfer learning, inductive transfer, or multitask learning.

With reference to a drawing, domain adaptation is described.

FIG. 4 is a diagram conceptually illustrating domain adaptation in which two pieces of data having statistical natures different from each other are used. In FIG. 4, a left side of FIG. 4 indicates data (first data and second data) of an initial state (before domain adaptation). A difference between positions of a horizontal direction of the figure indicates a difference between domains (statistical natures targeted) used for domain adaptation. For example, the first data represent an image based on illumination from right and the second data represent an image based on illumination from left.

A right side of FIG. 4 indicates data after conversion using domain adaptation. In first data and second data after conversion, domains relating to a predetermined statistical nature overlap, i.e. a statistical nature is matched.

Statistical natures of learning data and test data are matched by using domain adaptation before executing machine learning, and thereby performance degradation of machine learning due to a gap between statistical natures can be reduced.

As a representative domain adaptation method, domain adaptation using adversarial learning is known (see, for example, NPL 2).

In a method described in NPL 2, a data converter learns conversion of data in such a way as to be unable to discriminate to what domain data belong. In contrast, a class discriminator learns in such a way as to increase discrimination accuracy for discriminating a class of converted data. A domain discriminator learns in such a way as to increase discrimination accuracy for discriminating a domain of converted data. Learning in such a way as to be unable to discriminate to what domain data belong in the data converter is equivalent to learning in such a way as to decrease discrimination accuracy in the domain discriminator. In this manner, leaning of the domain discriminator is learning for increasing discrimination accuracy of a domain and learning of the data converter is learning for decreasing discrimination accuracy of a domain, and therefore the method described in NPL 2 is referred to as adversarial learning. The method described in NPL 2 converts data in such a way as to be unable to discriminate a domain, and thereby can acquire data in which a statistical nature in a domain to be processed is sufficiently close.

### CITATION LIST

### Patent Literature

[PTL 1] Japanese Unexamined Patent Application Publication No. 2010-092266

### Non Patent Literature

[NPL 1] Boqing Gong, Yuan Shi, Fei Sha, and Kristen Grauman, “Geodesic Flow Kernel for Unsupervised Domain Adaptation”, Proceedings of the IEEE Conference on Computer Vision and Pattern Recognition (CVPR), 2012, pp. 2066 to 2073

[NPL 2] Yaroslav Ganin, Victor Lempitsky, “Unsupervised Domain Adaptation by Backpropagation”, Proceedings of the 32nd International Conference on Machine Learning (PMLR), Volume 37, 2015, pp. 1180 to 1189

### SUMMARY OF INVENTION

### Technical Problem

A large number of processes are required in order to prepare supervised data. In contrast, it is generally easy to prepare unsupervised data. Therefore, in machine learning, semi-supervised learning using supervised data and unsupervised data is known.

When domain adaptation is applied to data used for semi-supervised learning in which domain information being information indicating to what domain data belong is a teacher, it is necessary for domain adaptation to use data-with domain information and data-without domain information.

However, with regard to domain adaptation of adversarial learning described in NPL 2, domain information is required in all pieces of data.

Therefore, in the method described in NPL 2, there has been an issue in that it is difficult to use data-without domain information. In other words, in the method described in NPL 2, there has been an issue in that it is difficult for the method described in NPL 2 to be applied to semi-supervised learning in which domain information is a teacher.

For example, as domain information in processing of the facial image, attribute information such as at least one of “illumination”, a “capturing angle”, and “characteristics of camera used for capturing” is conceivable. However, it is highly costly to prepare supervised data for attribute information in all pieces of data.

Therefore, with regard to domain adaptation in general machine learning, for example, the following methods are used.

A first method is a method of executing domain adaptation by using partial data that are provided with attribute information. However, in the first method, it is difficult to use data that are not provided with attribute information. In other words, the first method does not solve an issue in that it is difficult for data-without domain information to be applied to semi-supervised learning.

A second method is a method using rough information as domain information. Rough information is, for example, information (e.g. a “difference in a method of collecting data”) including various pieces of information (“illumination”, a “capturingg angle”, and “characteristics of camera used for capturing”). However, the second method uses rough information and therefore it is difficult to efficiently use prior knowledge related to attribute information. In other words, in the second method, there has been an issue in that it is difficult to increase accuracy of learning.

The techniques of NPL 1 and PTL 1 are not related to unsupervised data (data-without domain information), and therefore it is difficult to solve the above issues.

An object of the present invention is to provide a learning device and the like that solve the above issues and achieve semi-supervised learning using, in addition to data-with domain information, data-without domain information.

### Solution to Problem

A learning device according to one aspect of the present invention includes, in semi-supervised learning using domain information as a teacher: a data processing means for including a first neural network that outputs data after predetermined conversion by using, as input, first data including the domain information and second data not including the domain information, a second neural network that outputs a result of predetermined processing by using data after the conversion as input, and a third neural network that outputs a result of domain discrimination by using data after the conversion as input; a first-loss calculation means that calculates, by using the first data, a first loss being a loss in the result of the domain discrimination; a second-loss calculation means that calculates, by using the second data, a second loss being an unsupervised loss in the semi-supervised learning; a third-loss calculation means that calculates, by using at least a part of the first data and the second data, a third loss being a loss in the result of the predetermined processing; and a parameter modification means that modifies a parameter of each of the first neural network to the third neural network in such a way as to decrease the second loss and the third loss and increase the first loss.

A learning method according to one aspect of the present invention, includes, in semi-supervised learning using domain information as a teacher, by a learning device including a first neural network that outputs data after predetermined conversion by using, as input, first data including the domain information and second data not including the domain information, a second neural network that outputs a result of predetermined processing by using data after the conversion as input, and a third neural network that outputs a result of domain discrimination by using data after the conversion as input: calculating, by using the first data, a first loss being a loss in the result of the domain discrimination; calculating, by using the second data, a second loss being an unsupervised loss in the semi-supervised learning; calculating, by using at least a part of the first data and the second data, a third loss being a loss in the result of the predetermined processing; and modifying a parameter of each of the first neural network to the third neural network in such a way as to decrease the second loss and the third loss and increase the first loss.

A recording medium according to one aspect of the present invention records a program that causes, in semi-supervised learning using domain information as a teacher, a computer including a first neural network that outputs data after predetermined conversion by using, as input, first data including the domain information and second data not including the domain information, a second neural network that outputs a result of predetermined processing by using data after the conversion as input, and a third neural network that outputs a result of domain discrimination by using data after the conversion as input, to execute: processing of calculating, by using the first data, a first loss being a loss in the result of the domain discrimination; processing of calculating, by using the second data, a second loss being an unsupervised loss in the semi-supervised learning; processing of calculating, by using at least a part of the first data and the second data, a third loss being a loss in the result of the predetermined processing; and processing of modifying a parameter of each of the first neural network to the third neural network in such a way as to decrease the second loss and the third loss and increase the first loss.

### Advantageous Effects of Invention

According to the present invention, an advantageous effect of achieving semi-supervised learning using, in addition to data-with domain information, data-without domain information can be achieved.

### BRIEF DESCRIPTION OF DRAWINGS

FIG. 1 is a block diagram illustrating one example of a configuration of a learning device according, to a first example embodiment of the present invention.

FIG. 2 is a diagram schematically illustrating an NN of a data processing unit according to the first example embodiment.

FIG. 3 is a block diagram illustrating one example of a configuration of a learning device as a modified example.

FIG. 4 is a diagram conceptually illustrating domain adaptation in which two pieces of data different in statistical nature are used.

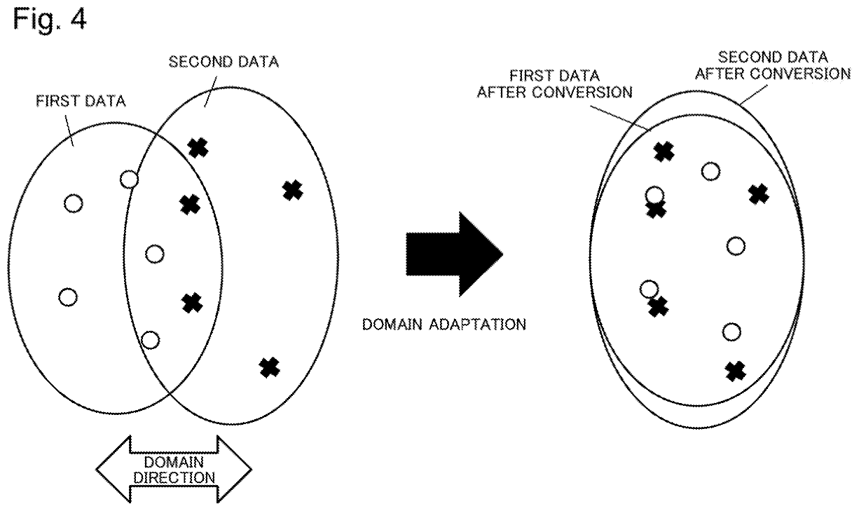

FIG. 5 is a diagram schematically illustrating data used for describing an advantageous effect of the learning device according to the first example embodiment.

FIG. 6 is a diagram schematically illustrating one example of a result in which general domain adaptation is executed for data in FIG. 5.

FIG. 7 is a diagram schematically illustrating one example of data conversion of the learning device according to the first example embodiment.

FIG. 8 is a diagram schematically illustrating an NN of a data processing unit according to a modified example.

FIG. 9 is a flowchart illustrating one example of an operation of the learning device according to the first example embodiment.

FIG. 10 is a block diagram illustrating one example of a configuration of a learning device that is a summary of the first example embodiment.

FIG. 11 is a block diagram illustrating one example of a hardware configuration of the learning device according to the first example embodiment.

FIG. 12 is a block diagram illustrating one example of a configuration of a data discrimination system according to the first example embodiment.

### EXAMPLE EMBODIMENT

Next, with reference to drawings, an example embodiment according to the present invention is described.

Drawings are used for describing the example embodiment according to the present invention. However, the present invention is not limited to illustration of drawings. A similar component in drawings is assigned with the same number, and repeated description of the component may be omitted. In drawings used for the following description, a component of a portion that is not related to description of the present invention may be omitted in description and may not always be illustrated.

Data used according to the example embodiment of the present invention are not limited. Data may be image data or voice data. In the following description, as one example, an image of a face may be used. However, this does not limit data to be targeted.

### First Example Embodiment

Hereinafter, with reference to drawings, a first example embodiment is described.

A learning device 10 according to the first example embodiment executes machine learning (semi-supervised learning) using supervised data and unsupervised data. More specifically, the learning device 10 executes data conversion, equivalent to domain adaptation, for data-with domain information being supervised data and data-without domain information being unsupervised data and executes machine learning such as class discrimination. In other words, the learning device 10 converts data-with domain information and data-without domain information as conversion equivalent to domain adaptation.

The present example embodiment does not limit a domain and a task to be learned.

An example for a domain and a task is described. Classification (discrimination of a class of an image) of a facial image and a non-facial image in a plurality of illumination positions is assumed.

In this case, one example of a domain is a position of illumination.

Domain information is information relating to a domain (e.g. information relating to an illumination position).

In this case, one example of a task is a classification operation of a class (a facial image and a non-facial image).

Task information is information relating to a task. Task information is, for example, a result of classification (discrimination of a class). In this case, one example of a loss related to task information is a loss (e.g. a loss based on an error of prediction in classification of a class) related to classification (discrimination of a class).

[Description of a Configuration]

First, a configuration of the learning device 10 according to the first example embodiment is described with reference to a drawing.

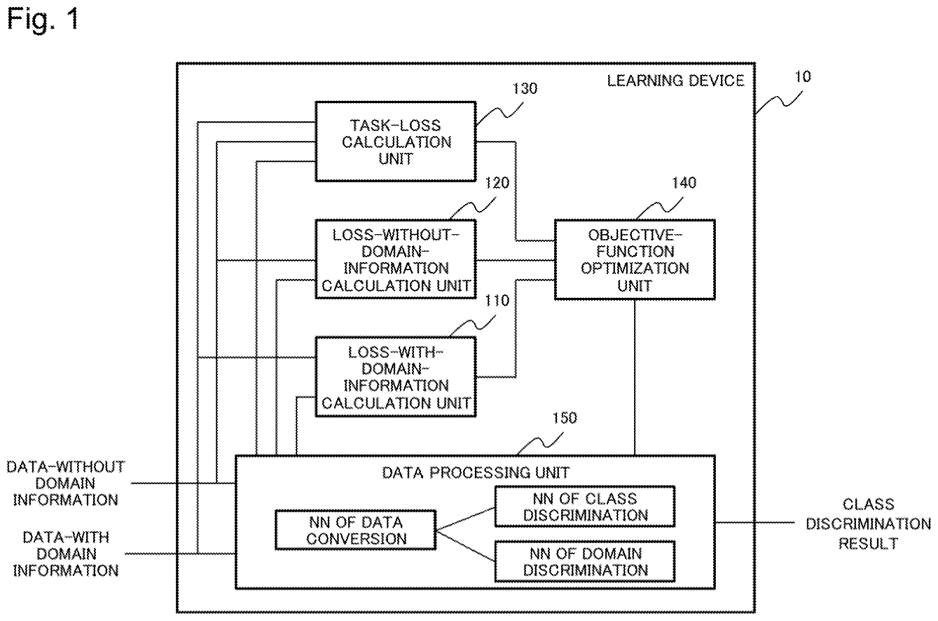

FIG. 1 is a block diagram illustrating one example of a configuration of the learning device 10 according to the first example embodiment of the present invention.

The learning device 10 includes a loss-with-domain-information calculation unit 110, a loss-without-domain-information calculation unit 120, a task-loss calculation unit 130, an objective-function optimization unit 140, and a data processing unit 150.

The loss-with-domain-information calculation unit 110 calculates, by using data (first data)-with domain information, a loss (first loss) related to domain discrimination.

The loss-without-domain-information calculation unit 120 calculates, by using data (second data)-without domain information, an unsupervised loss (second loss) in semi-supervised learning.

The task-loss calculation unit 130 calculates, by using at least a part of data-with domain information and data-without domain information, a loss (third loss) related to a result of predetermined processing (hereinafter, also referred to as a “task”) in the data processing unit 150.

When, for example, processing of the data processing unit 150 includes a task of discriminating a class, task information includes class information. Therefore, the task-loss calculation unit 130 may calculate, by using class information, a loss associated with a prediction error in discrimination of a class. This loss is one example of a discrimination loss.

The objective-function optimization unit 140 calculates or modifies, based on a first loss, a second loss, and a third loss, a parameter in such a way as to optimize an objective function including a parameter related to a task. There may be one or a plurality of expressions included in an objective function.

An optimum value of an objective function is a value determined according to the objective function. When, for example, an optimum value of an objective function is a minimum value, the objective-function optimization unit 140 calculates a parameter that minimizes the objective function. Alternatively, when an optimum value of an objective function is a maximum value, the objective-function optimization unit 140 calculates a parameter that maximizes the objective function. Alternatively, there is a restriction, the objective-function optimization unit 140 calculates a parameter that causes an objective function to have an optimum value in a range where the restriction is satisfied.

The objective-function optimization unit 140 may use, as an optimum value of an objective function, a value in a predetermined range including an optimum value, instead of a mathematical optimum value. The reason is that even when an optimum value can be theoretically determined, a calculation time for determining an optitnum value is very long. In addition, when an error in data is considered, an effective value has an allowable range.

As described later, the learning device 10 repeats modifying a parameter of an objective function. Therefore, until a parameter of an objective function converges, it may be possible that optimization based on the objective-function optimization unit 140 is optimization of a parameter based on a loss at the time but is not optimization of a final parameter. Therefore, an operation of the objective-function optimization unit 140 in a halfway of repeated operations may be referred to as modification of a parameter in a halfway of calculation of a final parameter.

The data processing unit 150 executes, by using a calculated parameter, predetermined processing (e.g. a task of discriminating a class). At that time, the data processing unit 150 converts data in such a way that a difference as a domain in data-with domain information and data-without domain information is reduced. The data processing unit 150 executes a task (processing) using a neural network (NN), as described later. Therefore, in the following description, a “task” and an “NN” may be used without being distinguished. For example, an “NN that executes a task” may be simply referred to as a “task” or an “NN”. However, this does not limit a task (processing) in the data processing unit 150 to an NN.

[Description of an Operation]

Next, with reference to a drawing, an operation of the learning device 10 according to the first example embodiment is described.

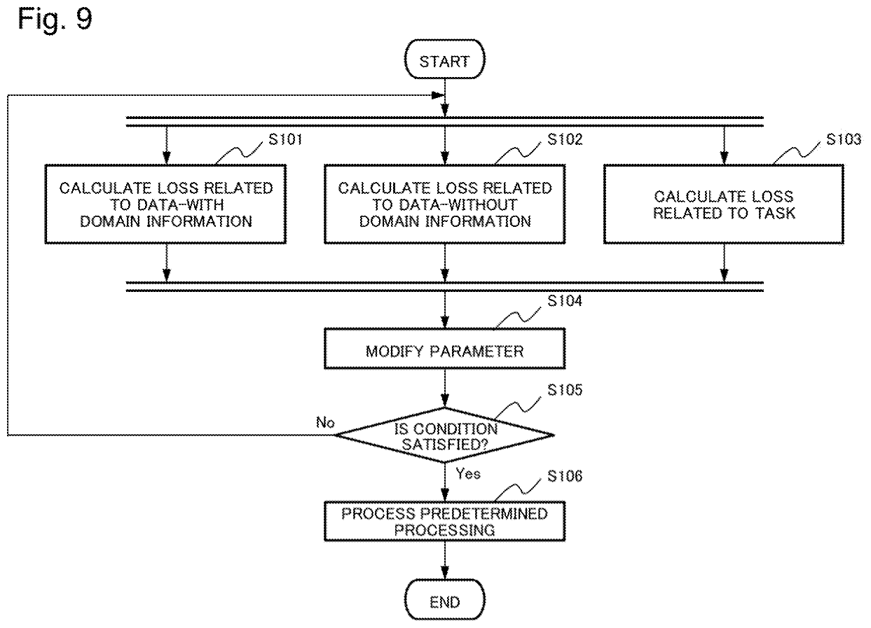

FIG. 9 is a flowchart illustrating one example of an operation of the learning device 10 according to the first example embodiment.

The learning device 10 executes semi-supervised learning using data-with domain information and data-without domain information. For more detail, the learning device 10 converts data-with domain information and data-without domain information in such a way that it is difficult to discriminate a domain.

The loss-with-domain-information calculation unit 110 calculates, based on data-with domain information, a loss (first loss) related to discrimination of a domain (step S101). For more detail, the loss-with-domain-information calculation unit 110 calculates, by using a parameter of a task (or an NN that executes a task) at that time, a loss (first loss) related to domain discrimination based on data-with domain information.

As illustrated in FIG. 9, the learning device 10 repeats an operation from steps S101 to S105. A “parameter at that time” is a parameter calculated by the objective-function optimization unit 140 in an operation of step S104 of a previous time. In a case of a first operation, a “parameter at that time” is an initial value of a parameter.

The loss-without-domain-information calculation unit 120 calculates a loss (second loss) related to data-without domain information (step S102). For more detail, the loss-without-domain-information calculation unit 120 calculates, by using a parameter at that time and data-without domain information, an unsupervised loss (second loss) in semi-supervised learning.

The task-loss calculation unit 130 calculates, by using at least a part of data-with domain information and data-without domain information, a loss (third loss) related to a task (step S103). For more detail, the task-loss calculation unit 130 calculates, by using a parameter at that time, a loss (third loss) related to a result of a task.

In the learning device 10, an order of operations from step S101 to step S103 is not limited. The learning device 10 may execute an operation from any step or may execute operations of two or all steps in parallel.

The objective-function optimization unit 140 modifies, based on the losses (the first loss, the second loss, and the third loss), a parameter in such a way as to optimize a predetermined objective function (step S104).

The learning device 10 repeats the operations until a predetermined condition is satisfied (step S105). In other words, learning device 10 learns a parameter.

A predetermined condition is a condition determined in accordance with at least one of data, an objective function, and an application field. A predetermined condition indicates that, for example, a change in a parameter is less than a predetermined value. Alternatively, a predetermined condition is the number of repetitions specified by a user or the like.

The data processing unit 150 executes, based on data-with domain information and data-without domain information, a predetermined task (e.g. a task of discriminating a class) by using a calculated parameter (step S106).

[A Detailed Example of an Operation]

Next, a detailed operation example of each component is described.

In the following description, a set of pieces of data to be targeted is added with task information, in addition to data themselves (e.g. facial image data). Data-with domain information are added with domain information. Hereinafter, data are designated as “x”, task information is designated as “y”, and domain information is designated as “z”. Data “x” and the like are not limited to data having one numerical value and may be a set of a plurality of pieces of data (e.g. image data).

One set of data is designated as (x,y,z). However, data-without domain information are a set (x,y,−) of data not including domain information “z”.

At least a part of a set of data may not necessarily include task information “y”. However, in the following description, it is assumed that a set of data includes task information.

First, the data processing unit 150 is described.

The learning device 10 used in the following description uses a neural network (NN) as a learning target of machine learning. For more detail, the data processing unit 150 executes a task using an NN.

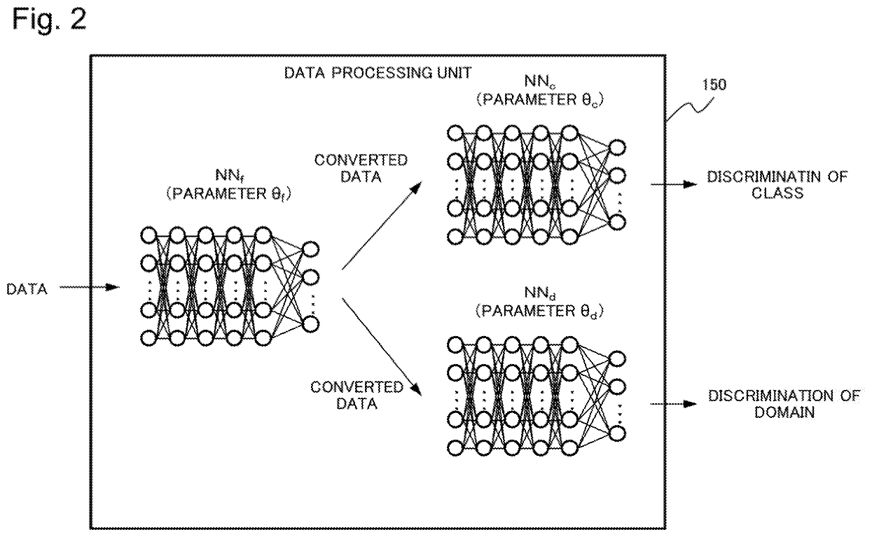

FIG. 2 is a diagram schematically illustrating an NN of the data processing unit 150 according to the first example embodiment. The NN includes three NNs (an NN_{f}, an NN_{c}, and an NN_{d}).

An NN_{f} (first neural network) is an NN that outputs data after predetermined conversion by using, as input, data-with domain information and data-without domain information. A task of the NN_{f} is a task of predetermined conversion. A task (processing) of the NN_{f} is a task (processing) equivalent to domain adaptation. However, a task of the NN_{f} is not limited to domain adaptation. A task of the NN_{f} may be conversion for improving a result of a class discrimination task and degrading a result of a domain discrimination task.

An NN_{c} (second neural network) is an NN that outputs class discrimination (or prediction of a class) of data after conversion by using data (data after conversion) converted by the NN_{f} as input. A task (processing) of the NN_{c} is a task (processing) of class discrimination. There are a plurality of classes. Therefore, the NN_{c} generally outputs a class as a vector.

An NN_{d} (third neural network) is an NN that outputs domain discrimination (or prediction of a domain) in data after conversion by using data (data after conversion) converted by the NN_{f} as input. A task (processing) of the NN_{d} is a task (processing) of domain discrimination. There are a plurality of domains. Therefore, the NN_{d} generally outputs a domain as a vector.

Parameters of the NN_{f}, the NN_{c}, and the NN_{d} each are designated as a parameter θ_{f} (first parameter), a parameter θ_{c} (second parameter), and θ_{d} (third parameter). However, this does not limit each parameter to one parameter. Some or all of the parameters may be configured by using a plurality of parameters.

In the following description, the learning device 10 causes parameters θ_{f}, θ_{c}, and θ_{d} to be a target of machine learning. However, a target of machine learning is not limited to the above. The learning device 10 may cause some of parameters to be a learning target. The learning device 10 may execute learning of parameters in a divided manner. The learning device 10 may learn, for example, a parameter θ_{c} after learning parameters θ_{f} and θ_{d}.

In the following description, it is assumed that a task of class discrimination is a task (a task of classifying data into two classes) of discriminating to which one of two classes data belong. It is assumed that a task of discriminating a domain is a task (a task of classifying data into two domains) of discriminating to which one of two domains data belong. It is assumed that task information “y” and domain information “z” are represented on a binary basis as follows.

y∈[0,1],z∈[0,1]

Next, a detailed example of an operation of each of the loss-with-domain-information calculation unit 110, the loss-without-domain-information calculation unit 120, the task-loss calculation unit 130, and the objective-function optimization unit 140 is described.

The loss-with-domain-information calculation unit 110 calculates, in data-with domain information, a loss (first loss) according to a prediction error of domain information based on an NN_{f} and an NN_{d}. According to the present example embodiment, a loss function for calculating a first loss is optional.

The loss-with-domain-information calculation unit 110 can use, for example, a negative logarithmic likelihood as a loss function. In this description, there are two domains. Therefore, the loss-with-domain-information calculation unit 110 may calculate, for example, by using a probability (P_{z}(z)) of domain information, a first loss (L_{ds}) related to data-with domain information, as follows.

L_{ds}=−log_{c}(P_{z}(z))

[P_{z}(0),P_{z}(1)]=[NN_{d}(NN_{f}(x|θ_{f})|θ_{d})]

A second equation indicates that a probability vector [P_{z}(0),P_{z}(1)] of domain information is a conditional posterior probability vector [NN_{d}(NN_{f}(x|θ_{f})|θ_{d})] (i.e. a posterior probability vector of a domain being output of an NN_{d}) of NN_{d} and NN_{f} in data (x).

The loss-with-domain-information calculation unit 110 calculates a first loss with respect to all pieces of data-with domain information.

The loss-without-domain-information calculation unit 120 calculates a loss (second loss) related to data-without domain information in semi-supervised learning. Data-without domain information are unsupervised data. Therefore, a second loss is an “unsupervised loss” in semi-supervised learning. According to the present example embodiment, an unsupervised loss (second loss) is optional.

The loss-without-domain-information calculation unit 120 may use, as an unsupervised loss, for example, an unsupervised loss used in general semi-supervised learning. The loss-without-domain-information calculation unit 120 may use, as a second loss, for example, a loss (L_{du}) used in a general semi-supervised support vector machine (SVM) as follows.

L_{du}=max(0,1−|P_{z}(0)−0.5|)

In the loss (L_{du}), a loss of data in a vicinity of a discrimination boundary (P=0.5) is large. Therefore, use of the loss (L_{du}) is equivalent to introduction of an assumption that there are less data in a vicinity of a discrimination boundary. Without limitation thereto, the loss-without-domain-information calculation unit 120 may calculate a loss that is larger as a distance between a discrimination boundary and data-without domain information decreases.

The loss-without-domain-information calculation unit 120 calculates a second loss with respect to all pieces of data-without domain information.

In this manner, the learning device 10 according to the present example embodiment calculates a loss related to data-without domain information.

The task-loss calculation unit 130 calculates, as a third loss related to a task, a loss (third loss) according to a prediction error in a task of an NN_{c}, by using task information of data-with domain information and data-without domain information. When task information is not included in partial data, the task-loss calculation unit 130 calculates a loss by using data including task information.

According to the present example embodiment, a method of calculating a third loss is optional. It is assumed that, for example, task information includes information (class information) related to a class. In this case, the task-loss calculation unit 130 may use a general discrimination loss of a class. Alternatively, the task-loss calculation unit 130 may use, as a third loss (L_{c}), a negative logarithmic likelihood of a probability (P_{y}(y)) of task information (class information) as described below.

L_{c}=−log_{c}(P_{y}(y))

[P_{y}(0),P_{y}(1)]=[NN_{c}(NN_{f}(x|θ_{f})|θ_{c)}]

A second equation indicates that a probability vector [P_{y}(0),P_{y}(1)] of class information is a conditional posterior probability vector [NN_{c}(NN_{f}(x|θ_{f})|θ_{d})] (i.e. a posterior probability vector of a class being output of an NN_{c}) of NN_{c} and NN_{f} in data (x).

The task-loss calculation unit 130 calculates a third loss with respect to all pieces of data including task information.

The objective-function optimization unit 140 calculates a parameter (or modifies a parameter), based on a first loss, a second loss, and a third loss, in such a way as to optimize an objective function. A method used by the objective-function optimization unit 140 is optional. The objective-function optimization unit 140 calculates, for example, in an objective function including a plurality of predetermined expressions, a parameter θ_{f} of an NN_{f}, a parameter θ_{c} of an NN_{c}, and a parameter θ_{d} of an NN_{d} in such a way as to simultaneously optimize all of the expressions.

In description according to the present example embodiment, as modification of a parameter, the objective-function optimization unit 140 learns, in learning of an NN_{c} and an NN_{d}, in such a way as to be able to discriminate these NNs with high accuracy, In contrast, the objective-function optimization unit 140 learns, in learning of an NN_{f}, in such a way as to increase accuracy of an NN_{c} and decrease accuracy of an NN_{d}. In this manner, the objective-function optimization unit 140 executes adversarial learning. One example of this relation is represented by using an expression as follows. “Arginin ( )” is a function for determining an argument (in this case, a parameter) that causes a function of parentheses to have a minimum value.

θ_{c}=argmin (L_{c})

θ_{d}=argmin (L_{ds}+L_{du})

θ_{f}=argmin (L_{c}−L_{ds}+L_{du})

These equations indicate the following.

(1) A parameter θ_{c} is a parameter that minimizes a loss (L_{c}) calculated by the task-loss calculation unit 130. This is to decrease a third loss.

(2) A parameter θ_{d} indicates a parameter that minimizes a sum of a loss (L_{ds}) calculated by the loss-with-domain-information calculation unit 110 and a loss (L_{dn}) calculated by the loss-without-domain-information calculation unit 120. This is to decrease a first loss and a third loss.

(3) A parameter θ_{f} indicates a parameter that decreases a loss (L_{c}) calculated by the task-loss calculation unit 130 and a loss (L_{du}) calculated by the loss-without-domain-information calculation unit 120 and increases a loss (L_{ds}) calculated by the loss-with-domain-information calculation unit 110. This is to decrease a second loss and a third loss and increase a first loss.

A parameter θ_{f} is calculated in such a way that a first loss (L_{ds}) increases. An increase in a first loss (L_{ds}) indicates a decrease in accuracy of domain discrimination of an NN_{d}. A fact that accuracy of an NN_{d} is low indicates that a domain is not discriminated, i.e. a statistical nature of data for each domain is similar.

A parameter θ_{f} is calculated in such a way that a second loss (L_{du}) and a third loss (L_{c}) decrease. A fact that these losses are small indicates that accuracy in discrimination of a class is high.

Therefore, in the above case, the objective-function optimization unit 140 calculates a parameter θ_{f} in such a way as to improve a discrimination property of a class in an NN_{f} while decreasing a discrimination property of a domain (e.g. a statistical nature of data for each domain is similar). Specifically, the objective-function optimization unit 140 calculates a parameter θ_{f} in such a way as to decrease a second loss (L_{du}) and a third loss (L_{c}) and increase a first loss (L_{ds}).

In contrast, a parameter θ_{d} is calculated in such a way as to decrease a first loss (L_{ds}) and a second loss (L_{du}). This is to improve accuracy in domain discrimination.

In other words, the objective-function optimization unit 140 achieves adversarial learning.

The data processing unit 150 converts, by using an NN_{f} applied with a parameter θ_{f} calculated in such a manner, data-with domain information and data-without domain information. The data processing unit 150 discriminates a class by using an NN_{c} applied with a calculated parameter θ_{c}. Therefore, the data processing unit 150 achieves conversion in which a discrimination property of a class is improved while a statistical nature in a domain is similar in data-without domain information, in addition to data-with domain information. In this manner, the learning device 10 can achieve semi-supervised learning using data-with domain information and data-without domain information.

The objective-function optimization unit 140 uses a loss (second loss) using data-without domain information in order to calculate an NN_{d}, a parameter θ_{d}, and a parameter θ_{f} of an NN_{f}. In other words, the objective-function optimization unit 140 applies semi-supervised learning also to calculation of these parameters. Therefore, the learning device 10 can achieve learning in which a gap in a statistical nature is less than when only data-with domain information are used.

### Description of Advantageous Effects

Next, advantageous effects of the learning device 10 according to the first example embodiment are described.

The learning device 10 according the first example embodiment has an advantageous effect of achieving learning using, also in semi-supervised learning, data-without domain information in addition to data-with domain information.

The reason is as follows.

The learning device 10 according the first example embodiment executes semi-supervised learning by using domain information as a teacher. The learning device 10 includes a loss-with-domain-information calculation unit 110, a loss-without-domain-information calculation unit 120, a task-loss calculation unit 130, an objective-function optimization unit 140, and a data processing unit 150. The data processing unit 150 include a first neural network that outputs data after predetermined conversion by using, as input, data-with domain information and data-without domain information. The data processing unit 150 includes a second network that outputs a result of class discrimination by using data after conversion as input and a third neural network that outputs a result of domain discrimination by using data after conversion as input. The loss-with-domain-information calculation unit 110 calculates a first loss being a loss in a result of domain discrimination by using data-with domain information. The loss-without-domain-information calculation unit 120 calculates a second loss being an unsupervised loss in semi-supervised learning by using data-without domain information. The task-loss calculation unit 130 calculates a third loss being a loss in a class discrimination result by using at least a part of data-with domain information and data-without domain information. The objective-function optimization unit 140 modifies a parameter of each of the first neural network to the third neural network in such a way as to decrease the second loss and the third loss and increase the first loss.

The learning device 10 calculates a loss (first loss) related to data-with domain information, a loss second loss) related to data-without domain information, and a loss (third loss) related to predetermined processing (a task). The learning device 10 calculates, by using the first to the third loss, a parameter of the data processina unit 150 in such a way as to optimize a predetermined objective function. The data processing unit 150 converts, by using the parameter, data-with domain information and data-without domain information and executes predetermined processing (e.g. a task of discriminating a class). In this manner, the learning device 10 can achieve semi-supervised learning using, in addition to data-with domain information, data-without domain information.

The objective-function optimization unit 140 can use adversarial learning. Therefore, the learning device 10 can achieve adversarial learning equivalent to domain adaptation also in semi-supervised learning including data-without domain information.

As a result, the learning device 10 can further improve accuracy in learning by using data-without domain information, compared with learning using data-with domain information.

Next, with reference to drawings, an advantageous effect is further described.

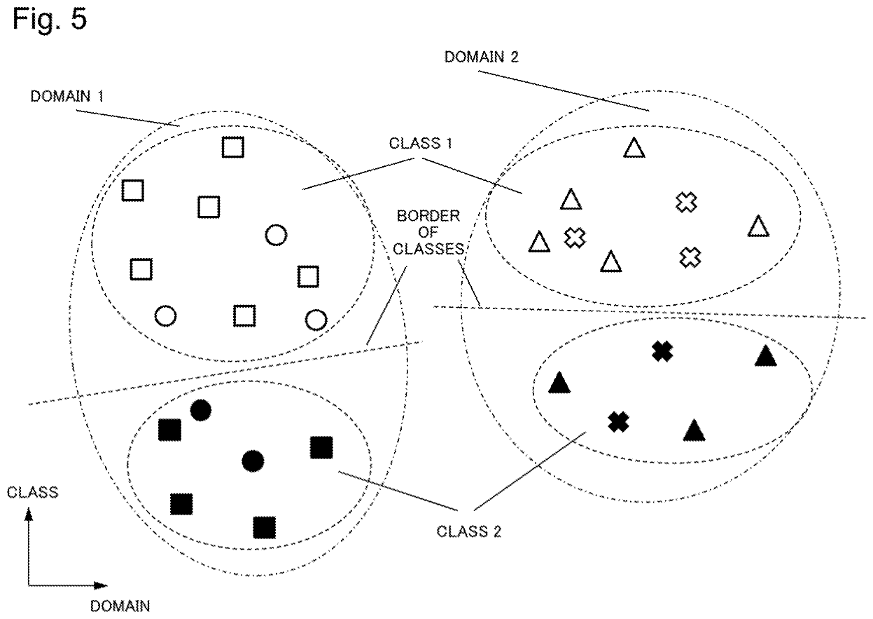

FIG. 5 is a diagram schematically illustrating data used for describing an advantageous effect of the learning device 10 according to the first example embodiment. In FIG. 5, a vertical direction is a discrimination direction of a class (e.g. a face or a non-face). A horizontal direction is a discrimination direction of a domain (e.g. a position of illumination). Data-without domain information are data in which a position of a domain is unclear, and therefore, originally, a position in FIG. 5 is indeterminate. However, for convenience of description, data illustrated in FIG. 5 are disposed in a position of a domain where information and the like at a time of acquiring the data are referred to. Data illustrated in FIG. 5 are disposed, for convenience of description, by referring to another piece of information and the like also with respect to a position of a class.

A range of an ellipse on a left side in FIG. 5 indicates a range of a first domain (a domain 1) before conversion. One example of a domain 1 is illumination from right.

Data having a circular shape indicate data-with domain information. A white circle indicates data of a class 1. A black circle indicates data of a class 2.

Data having a rectangular shape indicate data-without domain information. A void rectangle indicates data of a class 1. A black rectangle indicates data of a class 2.

A range of an ellipse on a right side indicates a range of a second domain (a domain 2). One example of a domain 2 is illumination from left.

Data having a diagonal-cross shape indicate data-with domain information. A void diagonal cross indicates data of a class 1. A black diagonal cross indicates data of a class 2.

Data having a triangular shape indicate data-without domain information. A void triangle indicates data of a class 1. A black triangle indicates data of a class 2.

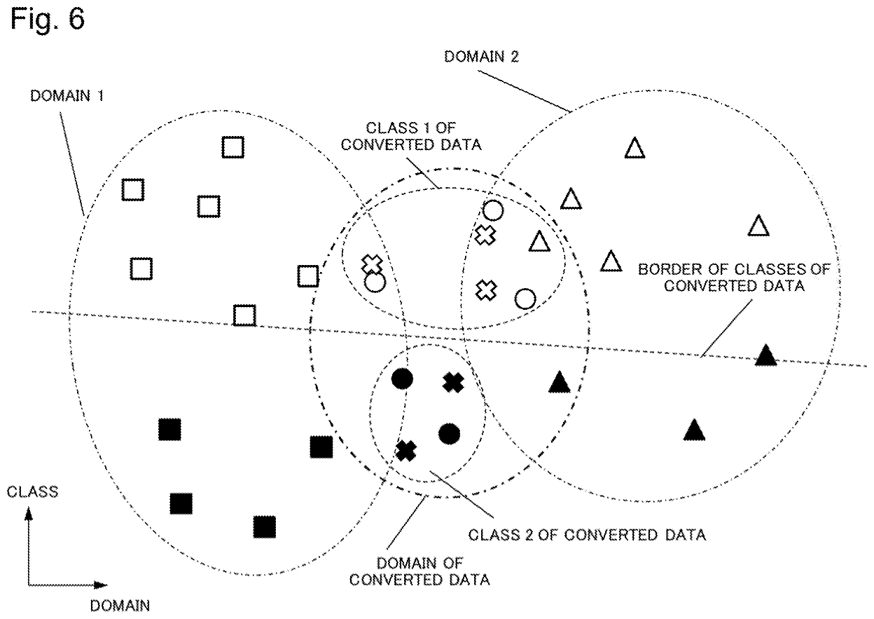

FIG. 6 is a diagram schematically illustrating one example of a result in which general domain adaptation is executed for data in FIG. 5.

As illustrated in FIG. 6, general domain adaptation uses data-with domain information. Therefore, it is difficult for general domain adaptation to use data-without domain information, and therefore a result using data-with domain information is acquired. In this example, discrimination of a class is inaccurate with respect to data-without domain information. For example, a class border is close to data-without domain information.

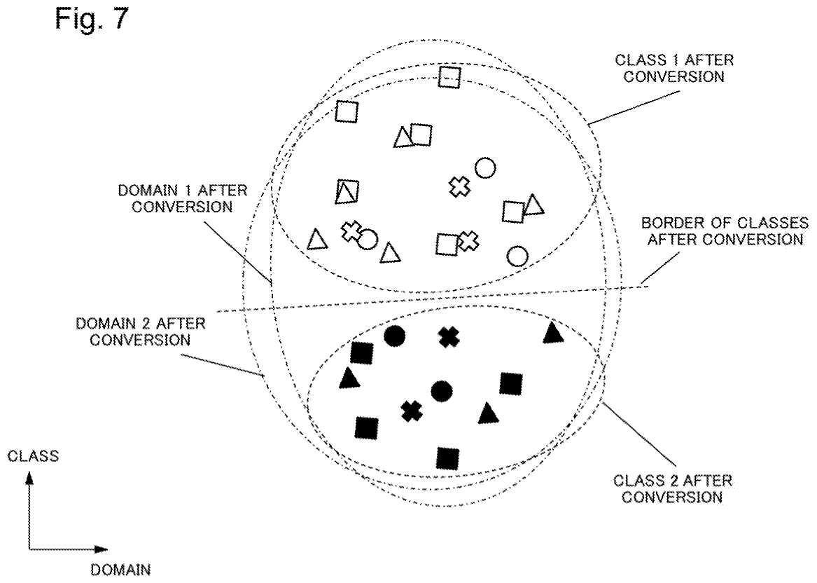

FIG. 7 is a diagram schematically illustrating one example of data conversion of the learning device 10 according to the first example embodiment.

As described in FIG. 7, the learning device 10 converts data-without domain information, in addition to data-with domain information, matches distribution of whole data with respect to a direction of a domain, and discriminates a class. Therefore, data illustrated in FIG. 7 do not include data close to a border of a class. In other words, the learning device 10 was able to learn appropriate discrimination of a class. In this manner, the learning device 10 can achieve, even when there are data-without domain information, learning in which data are converted in such a way that a statistical nature in a domain after data conversion is matched.

### Modified Example

A loss related to a task is not limited to the above. It may be difficult that, for example, class information described as one example of task information as described above is acquired. Therefore, as a modified example, a learning device 11 coping with a case where it is difficult to acquire task information is described.

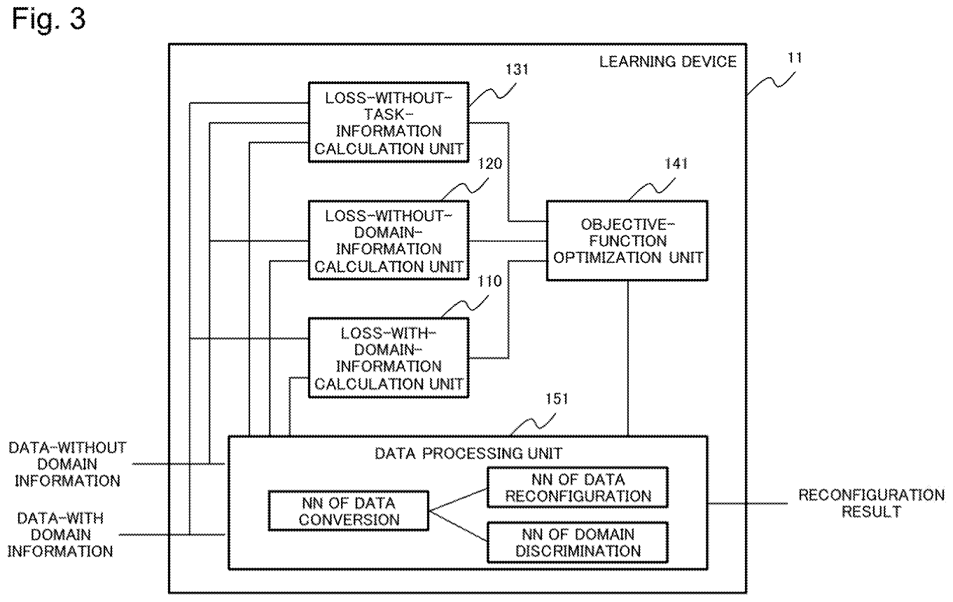

FIG. 3 is a block diagram illustrating one example of a configuration of the learning device 11 as a modified example. The learning device 11 includes a loss-without-task-information calculation unit 131, an obective-function optimization unit 141, and a data processing unit 151, instead of the task-loss calculation unit 130, the objective-function optimization unit 140, and the data processing unit 150.

The data processing unit 151 includes an NN, differently from the data processing unit 150.

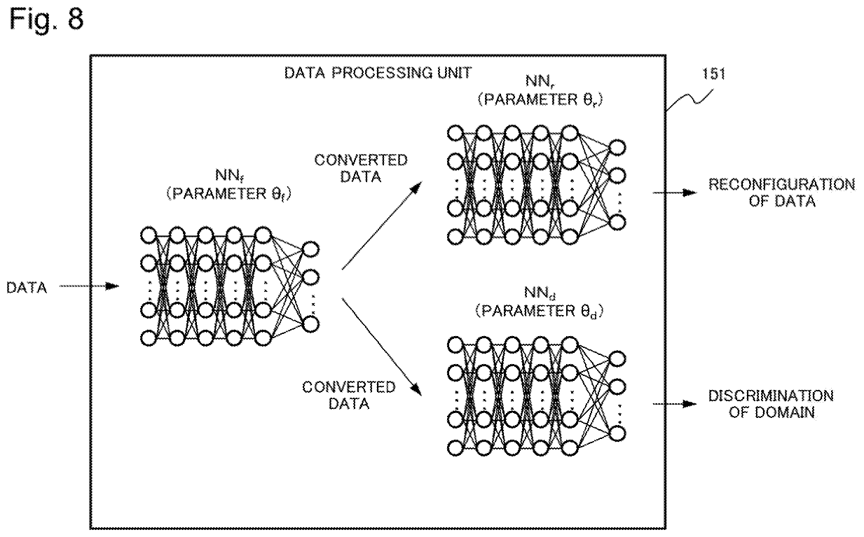

FIG. 8 is a diagram schematically illustrating an NN of the data processing unit 151 according to the modified example.

The data processing unit 151 includes three NNs (an NN_{f}, an NNᵣ, and an NN_{d}). NNs illustrated in FIG. 8 include an NNᵣ instead of an NN_{c}, compared with the NNs in FIG. 2.

An NN_{f} and an NN_{d} are the same as in FIG. 2.

An NNᵣ is an NN that outputs, by using data converted by an NN_{f} as input, data acquired by reconfiguring data after conversion. Reconfiguration is an operation of configuring again data after conversion to data equivalent to data before conversion. A task (processing) of an NNᵣ is a task (processing) of reconfiguration. An NNᵣ is one example of a third neural network.

The loss-without-task-information calculation unit 131 uses a reconfiguration error as a third loss. Specifically, the loss-without-task-information calculation, unit 131 uses, as a third loss, an “Lᵣ” described below, instead of an “L_{c}”. A loss (Lᵣ) is equivalent to a reconfiguration error. A reconfiguration error is a square error as described below.

Lᵣ=||x−NNᵣ(NN_{f}(x|θ_{f})|θ_{c})||²

A parameter θᵣ is a parameter of an NNᵣ. ||·|| is a norm.

The loss-without-task-information calculation unit 131 does not use task information such as discrimination of a task. Therefore, the loss-without-task-information calculation unit 131 can calculate a third loss even when it is difficult to acquire task information.

The objective-function optimization unit 141 optimizes a parameter by using Lᵣ instead of L_{c}.

The data processing unit 151 may use a parameter optimized by the objective-function optimization unit 141.

The learning device 11 has, similarly to the learning device 10, an advantageous effect of achieving semi-supervised learning using, in addition to data-with domain information, data-without domain information.

The reason is that the loss-without-task-information calculation unit 131 and the objective-function optimization unit 141 operate as described above and can calculate an appropriate parameter even when there is no task information. In addition, the data processing unit 151 executes a predetermined task (e.g. reconfiguration of data) by using the parameter.

The learning device 10 may include the loss-without-task-information calculation unit 131, in addition to the task-loss calculation unit 130. In this case, the objective-function optimization unit 140 may use, as a third loss, a loss calculated by the task-loss calculation unit 130 and a loss calculated by the loss-without-task-information calculation unit 131.

### Summary of the Example Embodiment

With reference to a drawing, a learning device 12 that is a summary of the learning device 10 and the learning device 11 is described.

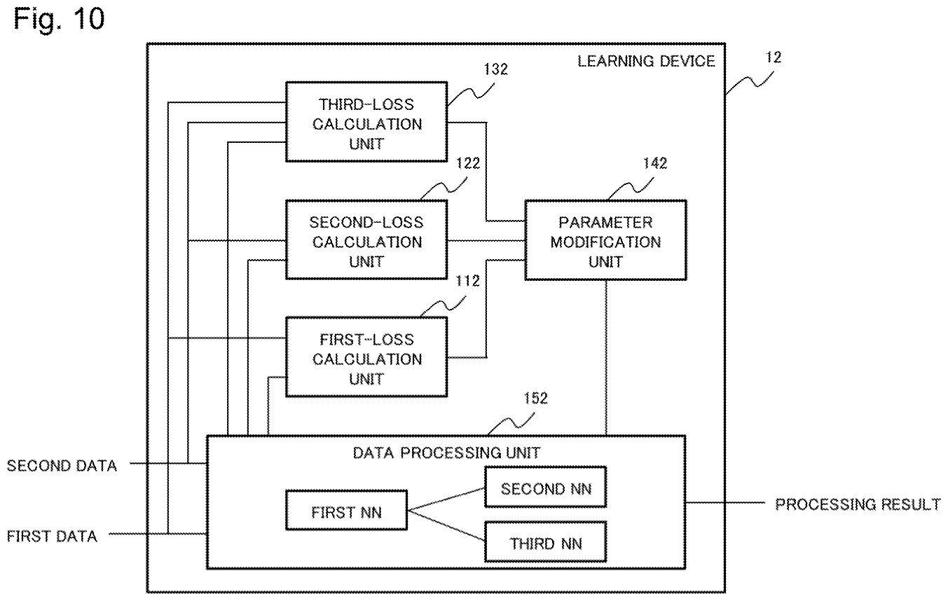

FIG. 10 is a block diagram illustrating one example of a configuration of the learning device 12 that is a summary of the first example embodiment.

The learning device 12 executes semi-supervised learning by using domain information as a teacher. The learning device 12 includes a first-loss calculation unit 112, a second-loss calculation unit 122, a third-loss calculation unit 132, a parameter modification unit 142, and a data processing unit 152. The data processing unit 152 includes a first neural network that outputs data after predetermined conversion by using, as input, first data including domain information and second data not including domain information. The data processing unit 152 further includes a second neural network that outputs a result of predetermined processing by using data after conversion as input and a third neural network that outputs a result of domain discrimination by using data after conversion as input. The first-loss calculation unit 112 calculates, by using first data, a first loss being a loss in a result of domain discrimination. The second-loss calculation unit 122 calculates, by using second data, a second loss being an unsupervised loss in semi-supervised learning. The third-loss calculation unit 132 calculates, by using at least a part of the first data and the second data, a third loss being a loss in a result of predetermined processing. The parameter modification unit 142 modifies a parameter of each of the first to the third neural network in such a way as to decrease the second loss and the third loss and increase the first loss.

One example of the first-loss calculation unit 112 is the loss-with-domain-information calculation unit 110. One example of the second-loss calculation unit 122 is the loss-without-domain-information calculation unit 120. One example of the third-loss calculation unit 132 is the task-loss calculation unit 130 and the loss-without-task-information calculation unit 131. One example of the parameter modification unit 142 is the objective-function optimization unit 140 and the objective-function optimization unit 141. One example of the data processing unit 152 is the data processing unit 150 and the data processing unit 151. One example of first data is data-with domain information. One example of second data is data-without domain information.

The learning device 12 configured in this manner has a similar advantageous effect to the advantageous effect of each of the learning device 10 and the learning device 11.

The reason is that components of the learning device 12 execute a similar operation to an operation of components of each of the learning device 10 and the learning device 11.

The learning device 12 includes a minimum configuration according to the first example embodiment.

[Hardware Configuration]

A hardware configuration of the learning device 10, the learning device 11, and the learning device 12 described above is described by using the learning device 10.

The learning device 10 is configured as follows.

Each of configuration units of the learning device 10 may be configured with, for example, a hardware circuit.

Alternatively, in the learning device 10, each of the configuration units may be configured by using a plurality of devices connected via a network.

Alternatively, in the learning device 10, a plurality of configuration units may be configured by using one piece of hardware.

Alternatively, the learning device 10 may be achieved as a computer device including a central processing unit (CPU), a read only memory (ROM), and a random access memory (RAM). The learning device 10 may be achieved as a computer device further including, in addition to the configuration, an input and output circuit (IOC). Alternatively, the learning device 10 may be achieved as a computer device further including, in addition to the configuration, a network interface (NIC).

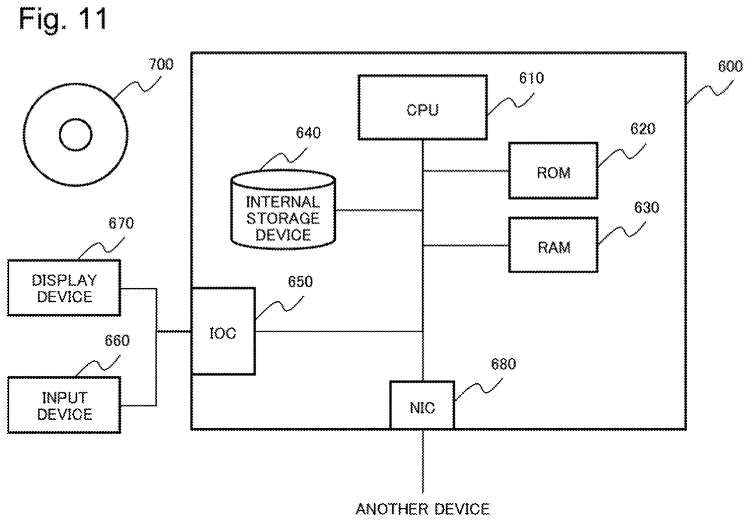

FIG. 11 is a block diagram illustrating one example of a configuration of an information processing device 600 that is one example of a hardware configuration of the learning device 10 according to the first example embodiment.

The information processing device 600 includes a CPU 610, a ROM 620, a RAM 630, an internal storage device 640, an IOC 650, and an NIC 680, and confiuures a computer device.

The CPU 610 reads a program from the ROM 620. The CPU 610 controls, based on the read program, the RAM 630, the internal storage device 640, the IOC 650, and the NIC 680. A computer including the CPU 610 controls these components and achieves a function of each of components illustrated in FIG. 1. The components are the loss-with-domain-information calculation unit 110, the loss-without-domain-information calculation unit 120, the task-loss calculation unit 130, the objective-function optimization unit 140, and the data processing unit 150.

The CPU 610 may use, when achieving each function, the RAM 630 or the internal storage device 640 as a transitory storage medium of a program.

The CPU 610 may read, by using a recording-medium read device, not illustrated, a program included in a recording medium 700 storing a program in a computer-readable manner. Alternatively, the CPU 610 may receive a program from an external device, not illustrated, via the NIC 680, store the received program on the RAM 630 or in the internal storage device 640, and operate based on the stored program.

The ROM 620 stores a program executed by the CPU 610 and fixed data. The ROM 620 is, for example, a programmable-ROM (P-ROM) or a flash ROM.

The RAM 630 temporarily stores a program executed by the CPU 610 and data. The RAM 630 is, for example, a dynamic-RAM (D-RAM).

The internal storage device 640 stores data and a program stored by the information processing device 600 on a long-term basis. The internal storage device 640 may operate as a transitory storage device of the CPU 610. The internal storage device 640 is, for example, a hard disk device, a magneto-optical disc device, a solid state drive (SSD), or a disk array device.

The ROM 620, the internal storage device 640, and the recording medium 700 each are a non-transitory recording medium. In contrast, the RAM 630 is a transitory recording medium. The CPU 610 can operate based on a program stored on the ROM 620, in the internal storage device 640, on the recording medium 700, or on the RAM 630. In other words, the CPU 610 can operate by using a non-transitory recording medium or a transitory recording medium.

The IOC 650 mediates data between the CPU 610, and an input device 660 and a display device 670. The IOC 650 is, for example, an IO interface card or a universal serial bus (USB) card. The IOC 650 may use a wireless manner without limitation to a wired manner such as a USB.

The input device 660 is a device for receiving an input instruction from an operator of the information processing device 600. The input device 660 is, for example, a keyboard, a mouse, or a touch panel.

The display device 670 is a device for displaying information to an operator of the information processing device 600. The display device 670 is, for example, a liquid crystal display.

The NIC 680 relays transfer of data to an external device, not illustrated, via a network. The NIC 680 is, for example, a local area network (LAN) card. The NIC 680 may use a wireless manner without limitation to a wired manner.

The information processing device 600 configured in this manner can has a similar advantageous effect to the advantageous effect of the learning device 10.

The reason is that the CPU 610 of the information processing device 600 can achieve, based on a program, a similar function to the function of the learning device 10.

[Data Conversion System]

Next, with reference to a drawing, a data discrimination system 20 including the learning device 10 is described. In the following description, the data discrimination system 20 may use the learning device 11 or the learning device 12, instead of the learning device 10.

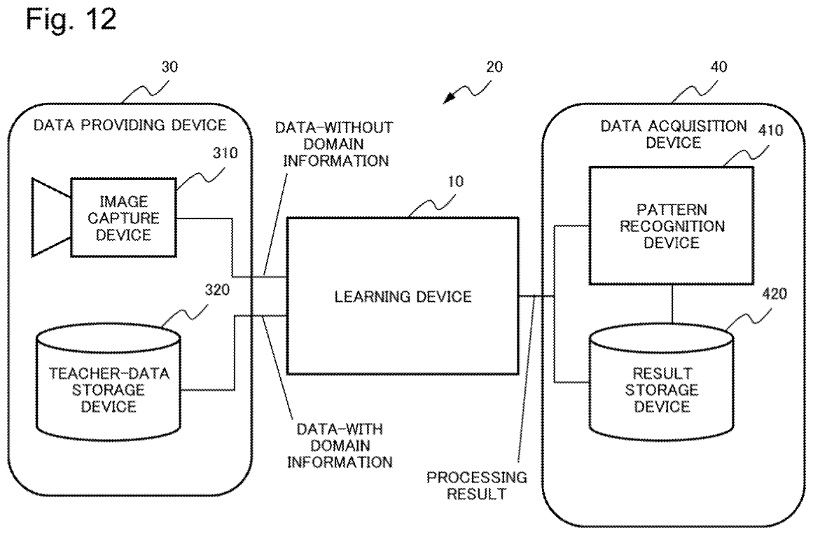

FIG. 12 is a block diagram illustrating one example of a configuration of the data discrimination system 20 according to the first example embodiment.

The data discrimination system 20 includes the learning device 10, a data providing device 30, and a data acquisition device 40.

The learning device 10 acquires data-with domain information and data-without domain information from the data providing device 30 and transmits, based on the operation described above, a result of data processing (a task) (e.g. a discrimination result of a class) to the data acquisition device 40.

The data providing device 30 provides data-with domain information and data-without domain information to the learning device 10.

The data providing device 30 is optional. The data providing device 30 may be, for example, a storage device that stores data-with domain information and data-without domain information. Alternatively, the data providing device 30 may be an imatte capture device that acquires image data, adds domain information to a partial image, sets the image data as data-with domain information, and sets remainine image data as data-without domain information.

The data providing device 30 may include a plurality of devices.

The data providing device 30 may include, for example, a teacher-data storage device 320 that stores data-with domain information and an image capture device 310 that acquires data-without domain information, as illustrated as one example in FIG. 12

The data acquisition device 40 acquires a processing result (e.g. a discrimination result of a class) from the learning device 10 and executes predetermined processing. The data acquisition device 40 executes, based on the acquired discrimination result, for example, pattern recognition of a facial image. The data acquisition device 40 may include a plurality of devices. The data acquisition device 40 may include, for example, a pattern recognition device 410 that recognizes a pattern by using a discrimination result and a result storage device 420 that stores at least either of a result of pattern recognition and an acquired discrimination result of a class.

The learning device 10 may include at least either of the data providing device 30 and the data acquisition device 40. Alternatively, the data providing device 30 or the data acquisition device 40 may include the learning device 10.

The data discrimination system 20 has an advantageous effect of being able to achieve appropriate processing (e.g. pattern recognition), by using, in addition to data-with domain information, data-without domain information.

The reason is that the learning device 10 processes data, as described above, based on learning using data-with domain information and data-without domain information acquired from the data providing device 30. In addition, the data acquisition device 40 achieves predetermined processing (e.g. pattern recognition) by using a processing result.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

This application is based upon and claims the benefit of priority from Japanese patent application No. 2017-224833, filed on Nov. 22, 2017, the disclosure of which is incorporated herein in its entirety by reference.

### INDUSTRIAL APPLICABILITY

The present invention is applicable to image processing and voice processing. In particular, the present invention is usable in an application for discriminating a pattern as in face recognition and object recognition.

### REFERENCE SIGNS LIST

10 Learning device

11 Learning device

12 Learning device

20 Data discrimination system

30 Data providing device

40 Data acquisition device

110 Loss-with-domain-information calculation unit

112 First-loss calculation unit

120 Loss-without-domain-in forma ion calculation unit

122 Second-loss calculation unit

130 Task-loss calculation unit

131 Loss-without-task-information calculation unit

132 Third-loss calculation unit

140 Objective-function optimization unit

141 Objective-function optimization unit

142 Parameter modification unit

150 Data processing unit

151 Data processing unit

152 Data processing unit

310 Image capture device

320 Teacher-data storage device

410 Pattern recognition device

420 Result storage device

600 Information processing device

610 CPU

620 ROM

630 RAM

640 Internal storage device

650 IOC

660 Input device

670 Display device

680 NIC

700 Recording medium

1. A learning device comprising, in semi-supervised learning using domain information as a teacher:
a memory; and
at least one processor coupled to the memory,
the processor performing operations, the operations comprising:
including a first neural network that outputs data after predetermined conversion by using, as input, first data including the domain information and second data not including the domain information, a second neural network that outputs a result of predetermined processing by using data after the conversion as input, and a third neural network that outputs a result of domain discrimination by using data after the conversion as input;
calculating, by using the first data, a first loss being a loss in the result of the domain discrimination;
calculating, by using the second data, a second loss being an unsupervised loss in the semi-supervised learning;
calculating, by using at least a part of the first data and the second data, a third loss being a loss in the result of the predetermined processing; and
parameter modification means for modifying a parameter of each of the first neural network to the third neural network in such a way as to decrease the second loss and the third loss and increase the first loss.

2. The learning device according to claim 1, wherein the operations further comprise
calculating, by using the first data, the first loss associated with a prediction error of the domain information.

3. The learning device according to claim 1, wherein the second neural network
executes, as the predetermined processing, class discrimination of data after the conversion, and
the operations further comprise
calculating the second loss according to a distance between a discrimination border being a result of the class discrimination and the second data, and
calculating, as the third loss, a prediction error in the class discrimination.

4. The learning device according to claim 1, wherein the second neural network
executes reconfiguration of data after the conversion, and
the operations further comprise
calculating, as the third loss, an error in the reconfiguration.

5. A learning method comprising,
in semi-supervised learning using domain information as a teacher,
by a learning device including a first neural network that outputs data after predetermined conversion by using, as input, first data including the domain information and second data not including the domain information, a second neural network that outputs a result of predetermined processing by using data after the conversion as input, and a third neural network that outputs a result of domain discrimination by using data after the conversion as input:
calculating, by using the first data, a first loss being a loss in the result of the domain discrimination;
calculating, by using the second data, a second loss being an unsupervised loss in the semi-supervised learning;
calculating, by using at least a part of the first data and the second data, a third loss being a loss in the result of the predetermined processing; and
modifying a parameter of each of the first neural network to the third neural network in such a way as to decrease the second loss and the third loss and increase the first loss.

6. A non-transitory computer-readable recording medium embodying a program causing a computer,
in semi-supervised learning using domain information as a teacher,
including a first neural network that outputs data after predetermined conversion by using, as input, first data including the domain information and second data not including the domain information, a second neural network that outputs a result of predetermined processing by using data after the conversion as input, and a third neural network that outputs a result of domain discrimination by using data after the conversion as input, to perform a method, the method comprising:
calculating, by using the first data, a first loss being a loss in the result of the domain discrimination;
calculating, by using the second data, a second loss being an unsupervised loss in the semi-supervised learning;
calculating, by using at least a part of the first data and the second data, a third loss being a loss in the result of the predetermined processing; and
modifying a parameter of each of the first neural network to the third neural network in such a way as to decrease the second loss and the third loss and increase the first loss.
